(19) United States
(12) Patent Application Publication
(10) Pub. No.: US 2026/0121476 A1
(43) Pub. Date: Apr. 30, 2026

(54) Slot Closure Element for a Rotor With Chamfers

(71) Applicant: Bayerische Motoren Werke Aktiengesellschaft, Muenchen (DE)

(72) Inventor: Philip MOERTH, Muenchen, DE (US)

(21) Appl. No.: 19/372,489

(22) Filed: Oct. 29, 2025

(30) Foreign Application Priority Data
Oct. 31, 2024 (DE) 10 2024 131 784.1

(51) Int. Cl. H02K 3/487; H02K 1/26; H02K 15/064; H02K 15/13

(52) U.S. Cl. CPC H02K 3/487; H02K 1/26; H02K 15/064; H02K 15/13

(57) ABSTRACT

A slot closure element for a rotor of an electric machine of a motor vehicle for closing a slot of a rotor body of the rotor includes a closure body for arrangement in the slot. The closure body includes contact pressure regions that press against an inner side of a radially outer slot boundary of the slot, and two axially projecting projections on axially opposite end faces of the closure body, each having a chamfer, wherein the chamfers seal the slots and are configured to convert an axial force exerted on the projections into a radial force acting on the closure body to radially press the contact pressure regions against the inner side of the radially outer slot boundary.

### CROSS REFERENCE TO RELATED APPLICATION

This application claims priority under 35 U.S.C. §119 from German Patent Application No. 102024131 784.1, filed October 31, 2024, the entire disclosure of which is herein expressly incorporated by reference.

### BACKGROUND AND SUMMARY

The invention relates to a slot closure element for a rotor of an electric machine of a motor vehicle for closing a slot of a rotor body of the rotor. The invention further relates to a rotor and a method for at least partially circumferential manufacture of a rotor.

In the present case, the focus is on electric machines for electrified motor vehicles, such as electric or hybrid vehicles. Such machines typically have a stationary stator and a rotor mounted so as to be rotatable relative to the stator. The rotor has magnetic field-exciting components, for example, permanent magnets or energizable rotor windings, which are held by a rotor body, for example, a rotor laminated core formed from axially stacked laminations. For this purpose, the rotor body typically has slots for accommodating the magnetic field-exciting components. It is known from the prior art to encapsulate the rotor with a potting compound to mechanically support the magnetic field-exciting components against high centrifugal forces during rotor rotation. Before the rotor is encapsulated, the slots are sealed with slot closure elements. To seal the slots, the slot closure elements can be inserted axially into the slots, for example, pressed in or loosely inserted. When pressing in the slot closure elements, a chip may form on the slot closure elements, which may be made of hard plastic, due to an offset of the individual laminations that affects the sealing contour. Loose insertion of the slot closure elements into the slots can lead to leaks, so that the slots are not completely sealed and potting compound escapes from the slots.

The object of the present invention is to provide an easy-to-manufacture rotor for an electric machine with reliably sealed slots.

This object is achieved according to the invention by a slot closure element, a rotor and a method for producing a rotor having the features according to the respective independent patent claims. Advantageous embodiments of the invention are the subject matter of the dependent patent claims, the description and the figure.

A slot closure element according to the invention for a rotor of an electric machine of a motor vehicle serves to close a slot of a rotor body of the rotor. The slot closure element has a closure body for arrangement in the slot, which closure body has contact pressure regions for pressing against an inner side of a radially outer slot boundary of the slot. The slot closure element furthermore has two axially projecting projections on axially opposite end faces of the closure body, each having a chamfer, wherein the chamfers for sealing the slot are designed to convert an axial force exerted on the projections into a radial force acting on the closure body for radially pressing the contact pressure regions against the inner side of the outer slot boundary.

The invention furthermore includes a rotor for an electric machine of a motor vehicle. The rotor comprises a rotor body with a plurality of slots which extend axially between two end sides of the rotor body. The rotor furthermore comprises magnetic field-exciting components which are arranged in the slots. The rotor furthermore comprises two covers which are arranged on the end sides of the rotor body and fastened to the rotor body. The rotor furthermore comprises per slot one slot closure element according to the invention, wherein the axial force is provided by the covers fastened to the rotor body and the chamfers of the projections form a non-positive connection with the covers.

In the case of a method according to the invention for at least partially circumferentially producing a rotor according to the invention, the slotted rotor body is provided first. The magnetic field-exciting components are then introduced into the slots. The slot closure elements are inserted into the slots. The contact pressure regions of the closure bodies are pressed radially against the inner surfaces of the slot boundaries to seal the slots by fastening the covers to the rotor body. The rotor can then be encapsulated with a potting compound. For this purpose, at least one of the covers can have at least one filling opening for introducing the potting compound into the slots.

The rotor can be used in an electric machine for a motor vehicle, which also has a stator mounted in a stationary manner with respect to the rotor. The electric machine is, in particular, a drive machine or traction machine for a motor vehicle formed as an electrified motor vehicle. The electric machine can, for example, be a current-excited synchronous machine (SSM). The electric machine is preferably an internal rotor machine, in which the stator surrounds the rotor and the rotor is rotatably mounted within a hollow-cylindrical stator body of the stator.

The rotor has the rotor body, which is formed in particular as a laminated core of axially stacked electrical sheet laminations. The rotor body is preferably manufactured in a salient-pole design for a rotor of a separately excited electric machine and has, for example, a ring-like rotor yoke through which a rotor shaft is guided. The rotor shaft is connected to the rotor body in a rotationally fixed manner. Distributed circumferentially on the rotor yoke are salient poles, each of which has a pole tooth projecting radially from the rotor yoke and, in particular, with parallel flanks, and a pole shoe radially adjacent to the pole tooth. A slot is formed between two adjacent salient poles and extends axially through the rotor body. In the case of a salient-pole rotor, the respective groove is delimited in the tangential direction or in the circumferential direction by the mutually facing tooth flanks of the pole teeth of the adjacent salient poles, which form lateral slot boundaries. In the radial direction, the respective slot is defined by an outer surface portion of the rotor yoke, which is located between the two tooth flanks and forms a slot base or inner slot boundary, and by the inner surfaces of the pole shoes of the adjacent salient poles, which form the inner side of the outer slot boundary. A pole gap between the pole shoes of the adjacent salient poles forms an access opening of the slot, via which a winding conductor, for example, a wire, can be introduced into the slot when winding around the pole teeth to form the rotor windings.

The salient poles can each support a rotor winding or rotor coil. In the radial direction, the pole shoes support the rotor windings and prevent the rotor windings from slipping off the pole teeth due to centrifugal force. Each rotor winding has two axial, slot-internal winding portions, which rest against the tooth flanks of the associated pole tooth. An axial winding portion of a first rotor winding and an axial winding portion of a second rotor winding wound around the adjacent pole tooth can be arranged per slot. In addition, each rotor winding has two end-side winding portions which are arranged on the axially opposite end sides of the rotor body. The end-side winding portions of all rotor windings form the winding heads. The rotor can also have star disks, wherein one star disk is arranged between each winding head and one end side of the rotor body. The star disks serve, among other things, to stabilize the winding heads against rotation-induced centrifugal forces. The axial winding portions of the adjacent rotor windings arranged in a slot are spaced apart from one another in the circumferential direction, with a free space formed between each winding portion. To stabilize the winding portions, the free space is filled with potting compound. For this purpose, the slot is closed and sealed in advance, at least in the radial direction, so that no potting compound escapes radially from the slots during the potting of the rotor.

To close and seal the slots, the slot closure elements are provided, each of which has a closure body. The closure bodies preferably have an elastic plastic, in particular an elastomer. The closure bodies are formed, for example, to be wedge-shaped and have in each case a radial portion which extends radially into the slot and a tangential portion which closes the slot, wherein tangentially opposite ends of the tangential portions have the contact pressure regions. The radial portions, in particular, have a substantially triangular cross-section, wherein flanks of the radial portion extending axially and radially through the slot are arranged adjacent to in each case one of the axial winding portions. The tangential portions close the respective pole gap and thus the slot. The contact pressure regions of the respective tangential portion are arranged within the slot and radially adjacent to or resting against the inner sides of the radially outer slot boundaries. For example, an upper side of the tangential portions has in each case a fold or a step at the tangentially opposite ends, which fold or step forms the respective contact pressure region.

The slot closure elements are inserted axially into the slots via one of the end sides of the rotor body. The insertion of the slot closure elements takes place with at least reduced force, so that there is at least reduced friction between the contact pressure surfaces of the closure bodies and the inner surfaces of the pole shoes, and thus no chip formation on the closure bodies of the slot closure elements. Sealing of the slots, therefore, does not occur when the slot closure elements are inserted into the slots. Rather, the closure bodies, which are loosely inserted into the slots, are pushed or pressed against the inner surfaces of the pole pieces via a radial force acting radially outwards, thus achieving the sealing of the slots. To exert the radial force, the slot closure elements each have two projections, wherein a first projection projects axially at a first end face of the associated closure body and a second projection projects axially at a second end face of the closure body. When the slot closure elements are arranged in the slots, the closure bodies are arranged within the slots, and the projections project axially from the slots. As a result, the projections also project beyond the end sides of the rotor body. The projections each have a chamfer or bevel. The bevel is formed such that a cross-section of the projections decreases in the axial direction, starting from the respective end face of the closure body. The chamfers of the projections are particularly directed radially inward, i.e., toward the rotational axis of the assembly and thus the rotor shaft of the rotor. In other words, the chamfers of the projections face away from the contact pressure regions of the associated closure body.

The rotor also has the covers, which also form support devices for the rotor. One cover is arranged on one of the end sides of the rotor body and, for example, at least partially covers the associated winding head. The covers can also form heat sinks for cooling the magnetic field-exciting components. The covers can each have a support ring arranged concentrically to the respective winding head, which extends from the end side of the rotor body at least over an axial winding head height and thus radially encloses the winding heads. The support rings can, for example, be designed as metallic bindings, such as steel bindings. The covers can furthermore each have a cover region, wherein the cover regions are arranged axially overlapping the winding heads, and the support rings extend axially between the respective end side and the respective cover region. The cover region and the support ring of a cover can be formed as one piece or in multiple pieces. The cover regions can, for example, have centrally arranged through-openings for the rotor shaft of the rotor. At least one cover region can also have at least one filling opening for filling the potting compound for potting the rotor. The covers, in particular the cover regions, are fastened to the rotor body by means of an axial force. For example, the axial force for fastening the covers can be provided by screws. The covers can, for example, be screwed indirectly via the star disk or directly to the rotor body.

The closure elements are pressed radially toward the outer slot boundaries with the aid of the covers axially fastened to the rotor body, so that the contact pressure regions are pressed from the inside against the outer slot boundaries. This creates a radial, non-positive connection between the slot closure elements and the rotor body. To provide this radial, non-positive connection, an axial, non-positive connection is formed between the slot closure elements and the covers. For this purpose, the undersides of the covers facing the end faces, for example, the cover areas, can have connecting elements with chamfers that run counter to the chamfers of the projections. When the covers are axially attached to the rotor body, the chamfers of the connecting elements slide over the opposing chamfers of the projections. This creates a non-positive or frictional connection on both axial sides in the form of a conical press connection between the annularly arranged slot closure elements and the covers. This conical connection or conical press connection exerts a radial force on the slot closure elements directed toward the inner sides of the slot boundaries.

The radial, non-positive connection between the slot closure elements and the rotor body, which is only created by the axial force, allows the slot closure elements to be loosely inserted into the slots. This prevents the slot closure elements from being damaged during insertion into the slots and provides a reliable seal of the slots for the subsequent encapsulation.

In one development of the invention, the slot closure element has a metallic rod which is mechanically connected to the closure body, wherein the projections are rod ends of the metallic rod. The metallic rod, which extends through the slot when the slot closure element is assembled, serves to stabilize the slot closure element. For example, the metallic rod and the closure body can be firmly bonded. For this purpose, the metallic rod can be overmolded with plastic during the production of the slot closure element, for example, which forms the closure body after curing. An axial length of the metallic rod is greater than an axial length of the associated closure body, so that the axially opposite, chamfered rod ends protrude beyond the end faces of the closure body, thereby forming the chamfered projections. For example, the metal rods are formed as round rods and thus, apart from the chamfered rod ends, have a circular rod cross-section.

It can be provided in this case that the metallic rod is formed as a heat-conducting rod for dissipating waste heat from the magnetic field-exciting components, for example, to the covers which act as heat sinks. In the case of the salient-pole rotor, the heat-conducting rods are arranged in the slots between the slot-internal winding portions of the two adjacent rotor windings. The heat-conducting rods are designed to cool the magnetic field-exciting components, absorbing their operational waste heat within the groove and discharging or dissipating it axially toward the rod ends and thus toward the end sides of the rotor body. For this purpose, it is advantageous if the closure bodies encase the respective heat-conducting rod for holding, particularly only in certain areas, so that the heat-conducting rods have encased portions along the axial direction and exposed, waste-heat-absorbing portions. This waste heat, which is dissipated toward the end sides, is transferred by the heat-conducting rods to the covers, which act as heat sinks and are, for example, actively cooled. The metallic rods are thus advantageously designed to be multifunctional and serve to mechanically strengthen the closure bodies and press the closure bodies against the outer slot boundaries, as well as to cool the magnetic field-exciting components.

It has been shown to be advantageous if, to prevent an electrically conductive path formed via the metallic rod between the covers, an insulation element is arranged in each case at the rod ends. When the rotor is assembled, the insulation elements are arranged between the rod ends and the covers. The insulation element is made of an electrically insulating material, such as plastic, and prevents an electromagnetically unfavorable electrical connection between the covers via the metallic rods. In particular, the insulation element is made of a thermally highly conductive material to ensure reliable heat dissipation of the waste heat transported via the rods to the covers. Alternatively or additionally, the metallic rods are formed from at least two rod segments, for example, arranged axially adjacent to one another, wherein the rod segments of a respective rod are mechanically connected by means of an electrically insulating and thermally conductive connecting element. For example, the connecting element can be a sleeve into which the rod segments are inserted on both sides and thus thermally and mechanically coupled, yet electrically insulated. The rod segments can also be inserted into one another, electrically insulated from one another in the connecting area, and connected, for example, in a form-fitting manner and firmly bonded via the connecting element.

The embodiments presented with reference to the slot closure element according to the invention and their advantages apply accordingly to the rotor according to the invention and to the method according to the invention.

Further features of the invention will become apparent from the claims, the figure, and the description of the figure. The features and combinations of features mentioned above in the description, as well as the features and combinations of features mentioned below in the description of the figures and/or shown alone in the figure, can be used not only in the respective combinations specified, but also in other combinations or on their own. The invention will now be explained in greater detail on the basis of a preferred exemplary embodiment and with reference to the drawing.

Other objects, advantages and novel features of the present invention will become apparent from the following detailed description of one or more preferred embodiments when considered in conjunction with the accompanying drawings.

### BRIEF DESCRIPTION OF THE DRAWING

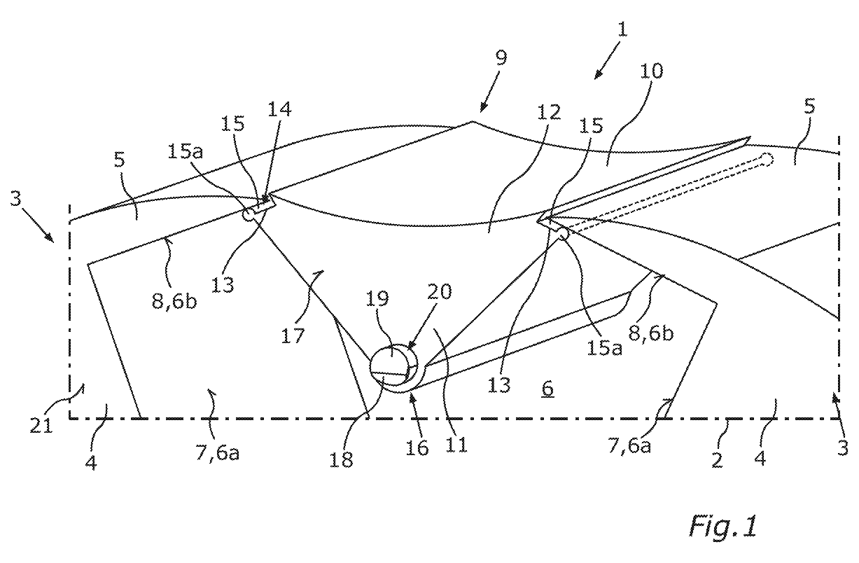

The single figure, FIG. 1, shows a perspective representation of a part of a rotor 1 of a separately excited electrical machine, for example, acting as a drive machine.

### DETAILED DESCRIPTION OF THE DRAWING

The rotor 1 has a rotor body 2, which is formed, for example, from axially stacked and packaged laminations. The rotor body 2 is manufactured here in a salient-pole design and has salient poles 3, each having a pole tooth 4 and a pole shoe 5. Between two salient poles 3, a slot 6 is formed, in which axial winding portions of two rotor windings formed by wrapping around the adjacent pole teeth 4 can be arranged. Mutually facing tooth flanks 7

of the pole teeth 4 form slot flanks and thus lateral slot boundaries 6a. Inner surfaces 8 of the pole shoes 5 form radially outer slot boundaries 6b. A gap between the pole shoes 5 of the adjacent salient poles 3 is closed by means of a slot closure element 9.

The slot closure element 9 has a closure body 10, which is arranged at least partially within the slot 6 and which is formed from an elastically deformable plastic. The closure body 10 has a radial portion 11 arranged within the slot 6 and a tangential portion 12 arranged in the gap. Tangentially opposite ends 13 of the tangential portion 12 have contact pressure regions 14 for pressing against the inner surfaces 8 of the pole shoes 5. The contact pressure regions 14 are formed here by folds 15 of the ends 13, wherein the folds 15 have a thickening 15a at the end side. Furthermore, the slot closure elements 9 have projections 16, which protrude on axially opposite end faces 17 of the closure body 10. The projections 16 each have a chamfer 18. The chamfer 18 faces away from the tangential portion 12 and the contact pressure regions 14. The chamfer 18 is directed radially inward. The projections 16 can be formed, for example, as rod ends 19 of a metallic rod 20, which extends axially through the closure body 10 and thus through the slot 4 and which is designed, for example, as a heat-conducting rod or heat-conducting pin for dissipating waste heat from the rotor windings.

The radial force required to press the contact pressure regions 14 against the inner surfaces 8 of the pole pieces 5 is converted from an axial force exerted on the chamfers 18 of the projections 16. The axial force can be provided, for example, by covers of the rotor, which are placed on the end sides 21 of the rotor body 2 and fastened there, for example, by screwing. For example, an underside of the covers facing the end sides 21 of the rotor body 2 can have opposing chamfers that bear against the chamfers 18 of the projections. These chamfers, arranged adjacent to one another, form a non-positive connection, which is designed to convert the axial force, provided, for example, by the screw connection between the cover and the rotor body 2, into the radial force acting on the closure bodies 10. As a result, the

contact pressure regions 14 are elastically deformed and pressed against the groove boundary 6b from the inside to seal the groove 6.

What is claimed is:

1. A slot closure element for a rotor of an electric machine of a motor vehicle for closing a slot of a rotor body of the rotor, the slot closure element comprising:
a closure body for arrangement in the slot, the closure body including contact pressure regions for pressing against an inner side of a radially outer slot boundary of the slot; and
two axially projecting projections disposed on axially opposite end faces of the closure body, each having a chamfer, wherein the chamfers are configured to seal the slot and to convert an axial force exerted on the projections into a radial force acting on the closure body for radially pressing the contact pressure regions against the inner side of the radially outer slot boundary.

2. The slot closure element according to claim 1, wherein the closure body includes an elastomer.

3. The slot closure element according to claim 1, wherein the closure body is configured in a wedge-shape and includes a radial portion which extends radially into the slot and a tangential portion which closes the slot, wherein tangentially opposite ends of the tangential portion include the contact pressure regions.

4. The slot closure element according to claim 2, wherein the closure body is configured in a wedge-shape and includes a radial portion which extends radially into the slot and a tangential portion which closes the slot, wherein tangentially opposite ends of the tangential portion include the contact pressure regions.

5. The slot closure element according to claim 3, wherein an upper side of the each of the tangential portions includes a fold at the tangentially opposite ends, the fold forming a respective contact pressure region.

6. The slot closure element according to claim 4, wherein an upper side of the each of the tangential portions includes a fold at the tangentially opposite ends, the fold forming a respective contact pressure region.

7. The slot closure element according to claim 1, further comprising a metallic rod which is mechanically connected to the closure body, wherein the projections are rod ends of the metallic rod.

8. The slot closure element according to claim 2, further comprising a metallic rod which is mechanically connected to the closure body, wherein the projections are rod ends of the metallic rod.

9. The slot closure element according to claim 7, wherein the metallic rod is formed as a heat-conducting rod that dissipates waste heat from at least one magnetic field-exciting component of the rotor arranged in the slot.

10. The slot closure element according to claim 7, wherein, to prevent an electrically conductive path formed via the metallic rod between two covers of the rotor, the metallic rod is formed from rod segments which are mechanically connected by an electrically insulating and thermally conductive connecting element.

11. The slot closure element according to claim 9, wherein, to prevent an electrically conductive path formed via the metallic rod between two covers of the rotor, the metallic rod is formed from rod segments which are mechanically connected by an electrically insulating and thermally conductive connecting element.

12. The slot closure element according to claim 7, wherein, to prevent an electrically conductive path formed via the metallic rod between two covers of the rotor, an insulating element is arranged at each of the rod ends.

13. The slot closure element according to claim 9, wherein, to prevent an electrically conductive path formed via the metallic rod between two covers of the rotor, an insulating element is arranged at each of the rod ends.

14. The slot closure element according to claim 10, wherein, to prevent an electrically conductive path formed via the metallic rod between two covers of the rotor, an insulating element is arranged at each of the rod ends.

15. A rotor for an electric machine of a motor vehicle comprising:
a rotor body including a plurality of slots which extend axially between two end sides of the rotor body;
magnetic field-exciting components arranged in the slots;
two covers arranged on and fastened to the two end sides of the rotor body; and
one slot closure element, per slot, according to claim 1, wherein the axial force is provided by the two covers fastened to the rotor body, and the chamfers of the projections form a non-positive connection with the two covers.

16. The rotor according to claim 15, wherein the rotor body includes a plurality of salient poles, wherein between each two adjacent salient poles a slot is formed for receiving magnetic field-exciting components including rotor windings of the rotor, and wherein radially outer slot boundaries of the slots are formed by pole shoes of the salient poles.

17. The rotor according to claim 15, wherein the two covers have a cover region on an underside of which connecting elements are formed, each of the connecting elements including a chamfer opposite the chamfer of a respective projection.

18. A method for producing a rotor according to claim 15, the method comprising:
providing the rotor body;
arranging the magnetic field-exciting component in the slots;
inserting the slot closure elements into the slots;
radially pressing the contact pressure regions of the closure bodies onto inner sides of the slot boundaries to seal the slots by fastening the covers to the rotor body.
